(19) United States
(12) Patent Application Publication
(10) Pub. No.: US 2005/0228110 A1
(43) Pub. Date: Oct. 13, 2005

(54) Continuous organic and inorganic matrix composite fibrils and methods for their production from carbon nanotubes

(76) Inventors: Frank K. Ko, Philadelphia, PA (US); Asharf A. Ali, Zagazig (EG); Amotz Geshury, Wynnewood, PA (US)

Correspondence Address: Licata & Tyrrell P.C., 66 East Main Street, Marlton, NJ, 08053, US

(21) Appl. No.: 11/016,281

(22) Filed: Dec. 16, 2004

Related U.S. Application Data
(60) Provisional application No. 60/532,459, filed on Dec. 24, 2003.

(51) Int. Cl. C08K 3/04

(52) U.S. Cl. 524/496

(57) ABSTRACT

Continuous nanoscale composite fibrils of carbon nanotube in a polymer matrix of polyacrylonitrile (PAN) or any other compatible polymer are provided. Methods for their production by electrospinning are also provided.

This patent application claims the benefit of priority from U.S. Provisional Application Ser. No. 60/532,459, filed Dec. 24, 2003, which is herein incorporated by reference in its entirety.

This invention was supported in part by funds from the U.S. government (NASA Grant NAG 101061 and NSF Grant DMR-0116645) and the U.S. government may have certain rights in the invention.

### FIELD OF THE INVENTION

The present invention provides continuous nanoscale composite fibrils prepared from carbon nanotube and a process for placing carbon nanotube into a continuous nanoscale composite fibril via electrospinning. These composite fibrils of the present invention show superior mechanical and electrical properties and can be used, for example, as reinforcement in a variety of composites and electrodes for a variety of electronic devices.

### BACKGROUND OF THE INVENTION

Significant progress has been made in the synthesis and characterization of single wall carbon nanotubes (Harris, P. Carbon Nanotubes and Related Structures, Cambridge University Press, Cambridge, UK 1999; Dresselhaus et al. Science of Fullerenes and Carbon Nanotubes, Academic Press, New York, 1996; Iijam, S. Nature 1991 354:56; Baughman et al. Science 2002 297:787). However, there remains a need for effective means to bridge the dimensional and property gap between nanotubes and engineering materials and structures (Calvert, P Nature 1999 399:210; Calvert, P. Potential Applications for Carbon Nanotubes (Ed.: T. Ebbesen) CRC Press, Boca Raton, Fla. 1997 p/277). In order to translate the superior properties of SWNT to mesoscale and macroscale structures, considerable effort has been devoted to the development of linear and planar SWNT assemblies (Mamedov et al. Nat. Mater. 2002 1:190; Vigolo et al. Science 2000 290:1331; Jiang et al. Nature 2002 419:801].

### SUMMARY OF THE INVENTION

An object of the present invention is to provide a continuous nanoscale composite fibril comprising well-dispersed and aligned carbon nanotube in the fibril. In a preferred embodiment, the composite further comprises polyacrylonitrile (PAN) or any other compatible polymer.

Another object of the present invention is to provide a method for producing a continuous nanoscale composite fibril with aligned carbon nanotube in the fibril. In this method, a solution of nanotube and polymer is electrospun into fibrils. In a preferred embodiment, the polymer is PAN or any other compatible polymer.

### DETAILED DESCRIPTION OF THE INVENTION

The present invention provides a method for incorporating carbon nanotubes (CNT) into polymer fibrils in an aligned and homogeneous arrangement. Incorporation of CNT into the polymer fibrils in an aligned and homogeneous arrangement is expected to improve the thermal conductivity, electrical conductivity, and mechanical properties of the fibrils (Mamedov et al. Nat. Mater. 2002 1:90; Chapelle et al. Synth. Met. 1999 103:2510; Curran et al. Synth. Met. 199 103:2559; Wood et al. Composites, Part A 2001 32:391). Thus, the method of the present invention provides a means for development of CNT/polymer compositions and reinforced carbon fibers with improved properties.

Carbon nanotube useful in the present invention may comprise single-wall nanotube (SWNT), multiwall nanotube (MWNT) as well as graphite nanoscroll and/or vapor grown carbon nanofiber (VGNF). Preferably the percent by weight of carbon nanotube ranges from 0.1% to 15% by weight of the solid polymer content.

As will be understood by those of skill in the art upon reading this disclosure, the methods described herein can be applied to a broad range of organic polymers as well as conductive or nonconductive polymers. A preferred polymer for use in the composites of the present invention is polyacrylonitrile (PAN) or another polymer with similar fiber diameter and/or conductivity and/or wetting ability to PAN such as pitch. Examples of additional organic polymers that can be used include, but are not limited to, aramid fibers such as Kevlar and olefins such as polyethylenes and polypropylene. Examples of additional conductive fibers that can be used include, but are not limited to, polyaniline (PANi) and polyethylenedioxythiophene (PEDT). Preferably the percent polymer by weight in the spinning dope ranges from about 3% to about 15%.

Fibrils of the present invention are produced via electrospinning. Electrospinning is an electrostatically induced self-assembly process wherein ultra-fine fibers are produced (Reneker, D. and Chun, I, Nanotechnology 1996 7:216). In the electrospinning process, a high voltage is generated between a negatively charged polymer fluid and a metallic fiber collector for random orientation or nanoscale fibril alignment. In this process, the polymer fluid is contained in a polymer reservoir with a capillary tip. The electrospinning of polymer solutions allows the formation of nanoscale (<100 nm) fibrils (Reneker, D. and Chun, I, Nanotechnology 1996 7:216; Ko et al. Proceedings of the American Institute of Aeronautics and Astronautics, American Institute of Aeronautics and Astronautics (AIAA) Reston, Va. 2002; MacDiarmid et al. Synth. Met. 2001:119-27)).

Fibers were produced in accordance with the present invention by electrospinning a solution of polyacrylonitrile (PAN) with purified high-pressure CO disproportionation (FEPCO) SWNTs (Bronikowski et al. J. Vac. Sci. Technol. 2001 19:1800; Chiang et al. J. Phys. Chem. B 2001 105:8297) dispersed in dimethylformamide (DMF), an efficient solvent for SWNTs (Ausman et al. J. Phys. Chem. B 2001 104:8911). Electrospinning was carried out under ambient temperature in a vertical spinning configuration using a 0.9 mm diameter glass pipette with a spinning distance of 15 cm driven by a voltage of 25 kV. Continuous yarn was manufactured along with fiber mats. To demonstrate the possibility of producing SWNT-reinforced carbon fibers, sheets of PAN nanofibrils spun with SWNTs were oxidized (stabilized) in air for 30 minutes at 200° C., carbonized for 1 hour in nitrogen at 750° C., and graphitized in nitrogen for 1 hour at 1100° C. This follows a standard process for carbon fiber synthesis from PAN (Pierson, H. Handbook of Carbon, Graphite, Diamond and Fullerenes: Properties, Processing and Applications, Noyes Publications, Park Ridge, N.J. 1993).

Solutions comprising PAN alone, polylactic acid (PLA) and SWNTs, and PLA alone were also electrospun into fibrils for comparison.

The inclusion of SWNTs in the PAN and PLA matrix fibril was confirmed using Raman spectroscopy analysis. The typical peaks of SWNT are the radial breathing mode (RBM) in the 100-275 cm⁻¹ range and tangential (stretching) modes in the 1500-1600 cm⁻¹ range. They could be seen in the PAN/SWNT fibrils and were not observed in the neat PAN fibrils. Spectra from the net polymer fibers at 514.5 nm and 780 nm excitation wavelengths were almost featureless. This serves as a direct confirmation of the successful filling of the fibrils with SWNTs.

The diameter of the SWNTs can be estimated from the RBM peaks because RBM frequency is inversely proportional to the diameter of a SWNT (Rao et al. Phys. Rev. Lett. 2001 86:3895; Weber et al. Raman Scattering in Materials Science, Spinger, Berlin 2000) following the equation
ω_{R}˜224 cm⁻¹/d (1)
where ω_{R} is the RBM frequency and d is the tube diameter in nanometers. The presence of at least 6 RBM peaks is observed in the range from 108-275 cm⁻¹. According to Equation 1, this corresponds to a tube diameter range of 0.8-2.1 nm. Since SWNTs exist in the form of bundles, tube-tube interactions within a bundle may cause approximately 6-20 cm⁻¹ up-shift in ω_{R} with respect to the corresponding value in isolated tubes (Rao et al. Phys. Rev. Lett. 2001 86:3895). Therefore, the tube diameter was estimated to range from 0.7 to 2.0 nm. A slight change in the relative intensity and position of Raman bands in the tubes embedded in the fibers could be due to the interaction of SWNTs with the polymer or carbon matrix, debundling, and other effects.

Transmission electron microscopy (TEM) analysis was used to study the distribution and orientation of the SWNTs. According to the TEM analysis, the SWNTs were distributed inhomogeneously in the PLA fibers. Only about 10% PLA fibers under observation were found to contain SWNTs. TEM images with higher magnification showed that these SWNTs were highly tangled, forming spherical agglomerates. Further, the SWNT/PLA nanocomposite fibril was characterized by a rough, cobble-stone-like surface morphology, similar to the one reported in AFM studies of an approximately 300 nm PAN/SWNT fiber (Ko et al. Proceedings of the American Institute of Aeronautics and Astronautics, American Institute of Aeronautics and Astronautics (AIAA) Reston, Va. 2002). The agglomerated microstructure would account for the inhomogeneous distribution of SWNTs in PLA/SWNT fibrils, and is believed to be detrimental to the mechanical and electronic properties of the polymer fiber.

In contrast, TEM observations of PAN/SWNT fiber mats showed that SWNTs maintained their straight shape and were parallel to the axis direction of the PAN fiber after electrospinning, indicating that a better alignment of SWNTs is achieved in PAN fibers versus PLA fibers. The improved orientation also resulted in a better distribution as nearly every investigated section of the polymer fibers contained at least some SWNTS. Thus, smooth and uniform fiber surfaces and SWNT that was aligned and attenuated to composite fibrils as fine as 50-100 nm were achieved by co-electrospinning PAN with up to 4% weight of SWNT.

The observed difference in SWNT orientation and distribution in PAN fibers versus PLA fibers is believed to be due, at least in part, to the smaller diameter of PAN fibers (50-200 nm) compared to that of PLA fibers (about 1 mm). It is believed that the smaller diameter of the fibers does not allow for the agglomeration of nanotubes. Additionally, the differences in conductivity and wetting ability of the two polymers may be important factors. Accordingly, as will be understood by those of skill in the art upon reading this disclosure, additional polymers with fibers of similar diameter to PAN and conductivity and wetting abilities similar to PAN can also be used in the composite fibrils of the present invention.

A smooth surface was also detected by AFM and TEM for the pristine PAN and PLA nanofibrils.

The effect of heat treatment or carbonizing on the composite fibers was also investigated by TEM on PAN/SWNTs. After heat treatment, the PAN/SWNT fiber kept its shape, but the microstructure significantly changed. Sometimes, SWNTs were found to stick out of the polymer fiber as a direct result of the shrinkage of PAN fibers, which lost hydrogen and nitrogen during the heat treatment. Shrinkage can be addressed by applying tension in accordance with routine techniques.

The SWNTs in the carbonized fibers were in the form of bundles or individual tubes and maintained their straight shape. The average diameter of the SWNTs was measured to be about 1.3 nm, in agreement with the Raman analysis results. On the other hand, PAN was found to be completely carbonized with turbostratic graphite layers formed. Raman spectroscopy analysis confirms the formation of disordered carbon as shown by weak D and G bands of graphite. Such a change in the microstructure after heat treatment potentially enables the manufacturing of carbon/carbon nanocomposites with improved mechanical and electrical properties, as well as high temperature performance.

The mechanical properties of CNT/PAN stabilized by exposure to 200° C. in oxygen conditions and neat PAN fibers placed on a mica substrate were compared. These experiments showed a nonlinear load-deformation relationship for the SWNT/PAN composite nanofibrils. This may be attributed to the finite deformation of the fiber under large load. The elastic modulus of the fiber was calculated using the linear portion of the load-deformation curve at small deformation and under low forces (<100 nN). A comparison of the modulus predicted by the rule of mixture assuming a SWNT modulus of 1 TPa showed a favorable departure from the prediction indicating a factor of greater than two of the SWNT effect. This could be due to a stiffening of the polymer as the result of interaction with the SWNTs, an underestimation of the modulus of SWNTs, or a higher volume fraction of nanotubes in the fiber (on average or in the measured sections). To validate the AFM test results, commercial carbon fiber with a known modulus of 210 GPa was measured using the AFM method described. A value of 207 GPa was obtained. Thus, values generated for electrospun fibers of the present invention measured by the described AFM method are believe to accurate. Additionally, a thermogravimetric analysis (TGA) study showed that the inclusion of SWNTs in a PAN matrix also enhanced the thermal stability of the polymer, thus suggesting structural changes in the polymer caused by the presence of nanotubes.

Thus, as shown herein composite polymer and carbon nanofibrils containing aligned nanotubes in a polymer matrix can be manufactured by a coelectrospinning process. Continuous yarns have been successfully fabricated. They contribute to thermal stability and provide a significant reinforcement effect at less than 3% volume nanotube. The carbon nanotube/polymer nanocomposite fibrils of the present invention, in their green or carbonized form can be used as reinforcement in linear, planar, and 3-dimensional preforms for a new generation of composites and fibrous assemblies. Such composites and assemblies are used in a wide range of applications requiring high specific size versus mass, high specific strength versus mass and/or high specific function versus mass. Examples include, but are in no way limited to solar sails, high altitude vehicles, electronic components, aerospace structures, aircraft structures, building constructions such as off shore oil platforms, automobile structural components and electronic packaging.

The following nonlimiting examples are provided to further illustrate the present invention.

### EXAMPLES

### Example 1

### Sample Preparation

All SWNTs used in the studies described herein were produced by the high pressure carbon dioxide (HiPCO) process. Raw material contained approximately 24% Fe catalyst by mass. The material was purified using a protocol similar to that described by Chiang et al. (J. Phys. Chem. B 2001 105:8297) wherein the raw SWNT was placed in a convection oven held at 225° C. for 16 hours. During this time, a slow flow of water-saturated air was passed through the oven. The material was then placed in concentrated HCl and stirred at room temperature for one day. Following this treatment, the nanotube/acid slurry was diluted with distilled water and transferred to a Buchner funnel assembly. A peristaltic pump supplied a slow drip of water to the slurry, which was washed for 3 days, at which time the effluent from the nanotube cake was measured to be pH 7.0. The material was then transferred in wet paste form into sealed bottles for the electrospinning studies.

### Example 2

### Characterization

Characterization of the composite fibers (PLA with 1-5 wt. % SWNTs and PAN with 1-4 wt. % SWNTS) was conducted by using Raman microspectroscopy, transmission electron microscopy (TEM), and atomic force microscopy (AFM). Raman spectra were recorded using Renishaw 1000 microspectrometer with a diode laser (780 nm excitation wavelength) for PLA fibers and an Argon ion laser (514.5 nm) for PAN fibers. These excitation wavelengths were chosen to decrease fluorescence of the polymer and obtain a high intensity of SWNT peaks compared to the polymer spectrum. TEM investigations were carried out using a JEOL 201OF microscope, which has a field emission electron gun and operates at 200 kV accelerating voltage. The polymer fibers spun with SWNTs were placed on a carbon coated copper grid for TEM investigation. The elastic modulus of the fiber was evaluated using AFM (Nanoscope Illa, Digital Instruments/Vecco, Santa Barbara, Calif.) based on the approach of Kracke and Damaschke (Appl. Phys. Lett 2000 77:361). This method utilizes the relationship
dfld(Δz)=(2/π^{1/2})E*A^{1/2}
where F is the normal force, d is the tube diameter, Δz is indentation depth, A is the contact area, and E* is the effective Young's modulus of the contact as defined by
1/E*=(1−v₁²)/E1+(1−v₂²)/E₂
Here, E₁, E₂, v₁, and v₂ are the elastic moduli and the Poisson's ratios of the sample and the tip, respectively. This method is applicable here due to the fact that the diameters of the fibers measured (50-500 nm) are much larger than the diameters of the contact area (approximately 5 nm). Measurements made on carbon fibers of similar dimensions with known mechanical properties have confirmed the applicability of this approach to the determination of the Young's modulus.

The AFM experiments were carried out using a transverse compression load deformation test by the cantilever deflection method. For these measurements triangular Si₃N₄ cantilevers 140 nm long, with a spring constant of 0.1 nN nm⁻¹ were used. These cantilevers with a pyramidal tip were obtained from Thermo-Microscopes, Sunnyvale, Calif. The elastic modulus and the Poisson ratio of the tip are assumed to be 130 GPa and 0.27 respectively (Kracke, B and Damaschke, B Appl. Phys. Lett 2000 77:361). The radius of the contact area is 5.0 nm, as estimated from the shape of the tip. Mica, with an elastic modulus of 171 GPa and Poisson ratio of 0.3 (Kracke, B and Damaschke, B Appl. Phys. Lett 2000 77:361), was used as a standard to calibrate the AFM.

1. A continuous nanoscale composite fibril comprising aligned carbon nanotube in a polymer matrix of polyacrylonitrile (PAN) or any other compatible polymer.

2. The continuous nanoscale composite fibril of claim 1 wherein the aligned carbon nanotube comprises single-wall nanotube, multiwall nanotube, graphite nanoscroll or vapor grown carbon nanofiber.

3. A method for producing the continuous nanoscale composite fibril of claim 1 comprising electrospinning a solution of purified carbon nanotube and polymer into fibrils.

4. The method of claim 3 wherein the polymer is PAN.

5. The method of claim 3 wherein the carbon nanotube comprises single-wall nanotube, multiwall nanotube, graphite nanoscroll or vapor grown carbon nanofiber.

6. The method of claim 3 further comprising carbonizing the electrospun carbon nanotube and polymer fibrils.

7. The method of claim 6 wherein the carbon nanotube and polymer fibrils are carbonized by heat treatment.
